(19) United States
(12) Patent Application Publication
(10) Pub. No.: US 2026/0238681 A1
(43) Pub. Date: Aug. 13, 2026

(54) LEVERAGING BROWSER EXTENSION WIDE DEPLOYMENT TO EXPEDITE NETWORK SECURITY TOOLS DEPLOYMENT AND TIME TO VALUE

(71) Applicant: Palo Alto Networks, Inc., Santa Clara, CA (US)

(72) Inventors: Liran Teper, Petah Tikva (IL); Ofer Ben-Noon, Tel Aviv (IL); Alona Miga Blend, Herzliya (IL); Omri Ivanir, Tel Aviv (IL); Shlomi Zrahia, Tel Aviv (IL)

(21) Appl. No.: 19/049,427

(22) Filed: Feb. 10, 2025

(51) Int. Cl. H04L 9/40

(52) U.S. Cl. CPC H04L 63/20; H04L 63/1425

(57) ABSTRACT

A system has been designed that leverages browser extension deployment across an organization to gain intelligent visibility across and into the organization and to rapidly generate security policies that secure the organization against cybersecurity threats without sacrificing user experience. Deployed instances of the browser extension harvest browsing and browser related data which are aggregated into a dataset for analysis. The system analyzes the dataset from different security perspectives to generate security policies for each of the perspectives. Each security perspective can correspond to a different SSE or SASE component. The automatically generated security policies can be deployed or provided for review and approval. With the disclosed system, an organization can secure itself without reducing employee productivity. In addition, an organization can evaluate cybersecurity products based on actual behaviors of users, cohorts/groups (e.g., departments), and the organization wide behavioral patterns.

### BACKGROUND

The disclosure generally relates to automatically generating security policies for an organization based on web browser data (e.g., CPC subclass H04L 62/00 or G06F 21/00).

Adoption of cloud computing and popularity of remote and mobile working faced the challenge of providing secure access to data centers by mobile users and remote workers. The challenge was not met by virtual private network (VPN) tunnels that provided secure connections for remote users and edge or perimeter security products that protected the data centers because of the scale of connections and resources when organizations relied more heavily on cloud computing. In addition, the adoption of myriad cloud computing services expanded attack surface and resulted in less defined perimeters.

Secure Access Service Edge (SASE) has risen as a decentralized security solution that scales efficiently and quickly responds to organizational or environmental changes. SASE is a convergence of security-as-a-service and networking-as-a-service that leverages wide area network (WAN) edge/software-defined WAN (SD-WAN) networking technologies. Aspects of SASE include a cloud secure web gateway (SWG), firewall-as-a-service (FWaaS), cloud-access security broker (CASB), SD-WAN, Domain Name System (DNS) security, zero trust network access (ZTNA), and support for managed and unmanaged devices.

Secure Service Edge (SSE) can be considered the security domain of SASE or SASE without SD-WAN. An SSE solution focuses on the cybersecurity aspects, such as ZTNA, CASB, SWG, and FWaaS.

### BRIEF DESCRIPTION OF THE DRAWINGS

Embodiments of the disclosure may be better understood by referencing the accompanying drawings.

FIG. 1 is a diagram of a system that harvests browser data via deployed browser extensions to efficiently generate security policies tailored to behaviors of an organization.

FIG. 2 is a flowchart of example operations for generating security policies for an organization based on browser data harvested from across the organization with a browser extension.

FIG. 3 is a flowchart of example operations for analyzing a dataset of harvested browser data for a security perspective.

FIG. 4 depicts an example computer system with a browser data harvester and a cybersecurity policy generator.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Terminology

The terms “cybersecurity policy” and “security policy” refer to a policy defined to be enforced as a protective cybersecurity measure by a security enforcement points, such as a SWG or firewall. A security policy can be one or more rules. Each rule specifies a value or a condition and a security action. A rule can specify multiple values and/or conditions associated with one or more security actions.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

### Overview

Cybersecurity providers often struggle with providing a seamless SSE or SASE solution because of the many components involved in providing the corresponding services. When initially deploying the various components to secure an organization, administrators likely lack intelligent visibility into the behavior of users across an organization and their devices, which can include unmanaged devices. Without insights into the devices and behaviors across an organization, administrators make uninformed decisions for security policy configuration to balance security and user experience. Moreover, the administrators manually configure the various components of the SSE or SASE solution.

A system has been designed that leverages browser extension deployment across an organization to gain intelligent visibility across and into the organization and to rapidly generate security policies that secure the organization against cybersecurity threats without sacrificing user experience. Deployed instances of the browser extension harvest browsing and browser related data which are aggregated into a dataset for analysis. The system analyzes the dataset from different security perspectives to generate security policies for each of the perspectives. The initial security policies can be rapidly deployed to establish initial security for an organization and provide time for administrators to fine tune the policies over time. Each security perspective can correspond to a different SSE or SASE component. The automatically generated security policies can be deployed or provided for review and approval. With the disclosed system, an organization can secure itself without reducing employee productivity. In addition, an organization can evaluate cybersecurity products based on actual behaviors of users, cohorts/groups (e.g., departments), and the organization wide behavioral patterns.

### Example Illustrations

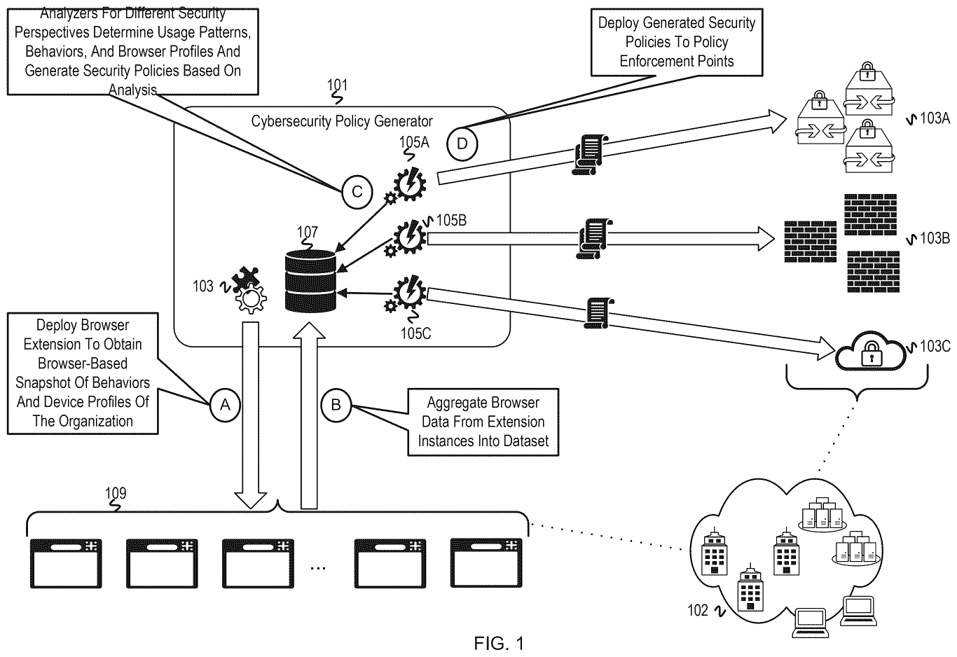

FIG. 1 is a diagram of a system that harvests browser data via deployed browser extensions to efficiently generate security policies tailored to behaviors of an organization. FIG. 1 depicts an organization 102 with data centers, remote users, and branch sites. A cybersecurity policy generator 101 of the organization 102 can be a standalone solution are part of a cybersecurity platform. Browsers 109 are distributed across the organization 102 on various devices, including managed devices of the organization, unmanaged devices, and home devices of remote users. FIG. 1 also depicts various cybersecurity products of the organization 102. The depicted cybersecurity products include SWGs 103A, firewalls 103A (e.g., hardware firewalls, software firewalls, FWaaS), and a CASB 103C.

FIG. 1 is annotated with a series of letters A-D representing stages of operations, each stage corresponding to one or more operations. Although these stages are ordered for this example, the stages illustrate one example to aid in understanding this disclosure and should not be used to limit the claims. Subject matter falling within the scope of the claims can vary from what is illustrated.

At stage A, the cybersecurity policy generator 101 deploys a browser extension 103 across the organization 102 to obtain a browser-based snapshot of behaviors and device profiles of the organization 102. The cybersecurity policy generator 101 can deploy the browser extension 103 via portal, e-mails, push notifications, a marketplace for the organization, etc. Each user will install an instance of the browser extension 103 to a corresponding one of the browsers 109. The browsers 109 can include a myriad of browsers from different developers and hosted on various platforms. The instances of the browser extension 103 will obtain a snapshot of browser-based data that will be analyzed to determine behavioral patterns and profiles of the devices/platforms being used within the networks of the organization 102.

At stage B, the cybersecurity policy generator 101 aggregates the snapshots of browser data from the extensions into a dataset. In FIG. 1, the dataset is hosted in a repository 107 (e.g., a data warehouse, data lake, database, etc.). The harvesting and aggregation can vary by implementation. The instances of the browser extension 103 may communicate the snapshots according to a schedule, responsive to a request from the cybersecurity policy generator 101, immediately upon obtaining the data, etc. The instances of the browser extension 103 may post or publish harvested browser data to a location configured in the browser extension 103 and the cybersecurity policy generator 101 pre-process (e.g., format or organize) the posted/published data for writing into a record or file of the repository 107.

At stage C, analyzers 105A-105C of the cybersecurity policy generator 101 analyze the dataset for one of multiple cybersecurity perspectives (“security perspectives”) corresponding to the cybersecurity products 103A, 103B, 103C. This illustration presumes that each of the analyzers 105A-105C can analyze the dataset as arranged in the repository 107. It may be the case that the analyzers 105A-105C are programmed to analyze data in at least two different arrangements. Accordingly, the cybersecurity policy generator 101 may pre-process the harvested data to organize and store the data as suitable for the analyzers 105A-105C. As one example, an analyzer may be programmed to parse hierarchically structured data while another analyzer is programmed to consume unstructured data. The analyzers 105A-105C analyze the dataset to determine usage patterns and browser and/or device profiles. Based at least on the determined usage patterns and browser profiles, the analyzers 105A-105C generates security policies. The analyzer 105A analyzes the dataset to determine usage patterns relevant to the SWGs 103A. For example, the analyzer 105A analyzes the dataset to determine domains and/or uniform resource locators (URLs) corresponding to web-based applications or services that are most often used and are trusted, and generates security policies that identifies these highly used and trusted applications and services to be allowed. The analyzer 105B analyzes the dataset to determine similar usage patterns with respect to often used applications and services but at a network layer to determine source and destination addresses and session information, and generates security policies for the firewalls 103B. The analyzer 105C analyzes the dataset to determine authentication behaviors and patterns of accessing digital assets of the corporation and generates a data leakage prevention (DLP) security policy for the CASB 103C.

At stage D, the cybersecurity policy generator 101 deploys the generated security policies to policy enforcement points. The analyzer 105A deploys its generated security policies to the SWGs 103A. The analyzer 105B deploys its generated security policies to the firewalls 103B. The analyzer 105C deploys its generated security policies to the CASB 103C.

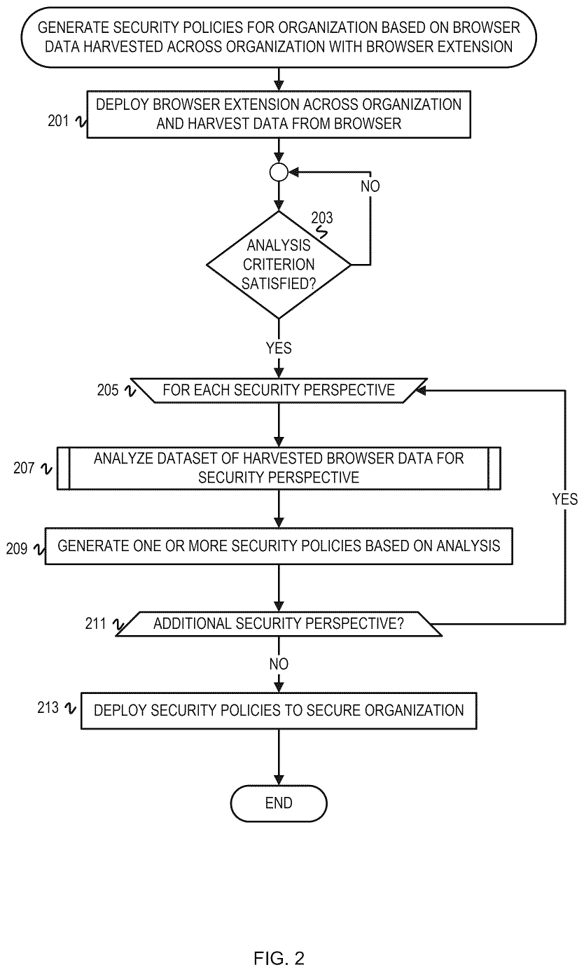

FIG. 2 is a flowchart of example operations for generating security policies for an organization based on browser data harvested from across the organization with a browser extension. As described earlier, harvesting the browser data allows an organization to gain visibility into the behaviors of users, cohorts, and the organization. This visibility allows intelligent security policies to be created that do not impede productivity and do not compromise security because the behaviors represented in the harvested data will provide informative insights about a usage and quickly map that usage to users via their browsers.

At block 201, the cybersecurity policy generator deploys a browser extension across an organization and harvests data from browsers across the organization. As previously described, deployment can vary by organization and/or preference (e.g., portal, e-mail, etc.). For deployment, each user will install or add to a browser they identify in a download interface. Thus, an instance of the browser extension will be provided that is suitable for the browser identified by the user. The browser extension instance will be programmed with a hook or calls to an application programming interface (API) of the target browser. With the hook or API calls, the browser extension will harvest browser data. Examples of browser data that would be harvested to inform construction of security policies include past visited URLs, downloaded files, saved passwords, cookies, browser configurations, configuration exceptions, time of actions, location logs, connected devices, user information, user preferences including privacy preferences, current open tabs, blocked activities, information from other synched browsers, and additional endpoints and devices. The cybersecurity policy generator can aggregate the harvested data into one or more datasets for per-security perspective analysis.

To address privacy and/or regulatory compliance, deployment and/or data acquisition can be conducted in a manner that preserves privacy and/or complies with data privacy regulations. For instance, the download interface for the browser extension can notify a user of the data being harvested and allow some types of data to be excluded and obtain consent. The browser extension can be programmed to anonymize the data before communicating the acquired data. The browser extension can be programmed to encode the harvested data in a manner consistent with an encoding scheme used for training the analyzers.

At block 203, the cybersecurity policy generator determines whether an analysis criterion is satisfied. While the analysis criterion likely relates to sufficiency of harvested data, implementations can vary. A criterion to trigger analysis of harvested data can be based on any one or more of all browser extension instances reporting, whether a data has been harvested for a cohort (e.g., department), whether a time limit as expired, etc. If the analysis criterion is not satisfied, then operational flow returns to block 203, presumably after a time period expires or an event occurs (e.g., completion of harvesting notification). If the analysis criterion is satisfied, then operational flow proceeds to block 205.

At block 205, the cybersecurity policy generator begins analysis operations for each security perspective. While this example indicates an iterative approach to the analysis, the analysis for different security perspectives can be in parallel.

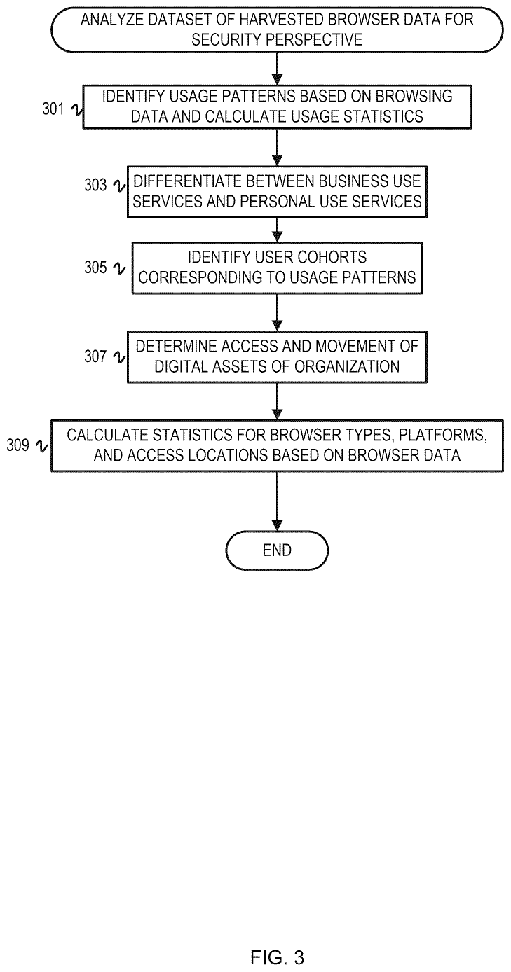

At block 207, the cybersecurity policy generator analyzes dataset of harvested browser data for each security perspective. FIG. 3 provides a few example operations for analysis.

At block 209, the cybersecurity policy generator generates one or more security policies based on the analysis. The analysis for a security perspective can yield conditions, rules, or identifiers to build a rule. The organization may have a security policy template defined for each security perspective. A security policy may involve restricting applications on an endpoint, traffic inspection, application usage, authentication, etc. Examples of the organizational aspects impacted by the security policies generated based on analysis of the browser data include Web access, DLP, file security, personalization, network security, security of other browser extensions, private applications, proxy, productivity, and endpoint executables. To generate a security policy, the cybersecurity policy generator can populate a template based on the conditions, rules, and/or identifiers determined from the analysis. For example, a DLP template may specify that use of a personal service triggers one of multiple security actions defined for different risk levels (e.g., isolates a personal browsing session or logout of enterprise applications). Analysis from the DLP perspective may identify users with risky behaviors and populate the template with the high-risk level security action. Embodiments can employ a foundation model (e.g., a language model) to generate security policies. For instance, the cybersecurity policy generator can construct a prompt with a task to generate a cybersecurity policy for a specified security perspective and include the usage patterns determined from analyzing the browser data and a cybersecurity policy template for the security perspective. The cybersecurity policy generator can then submit the prompt and parse the response to generate a security policy.

At block 211, the cybersecurity policy generator determines whether analysis is to be done for another security perspective. If analysis is to be done for another security perspective, then operational flow returns to block 205. Otherwise, operational flow proceeds to block 213.

At block 213, the cybersecurity policy generator deploys security policies to secure the organization. Each security perspective will correspond to a security product or service and policies will be deployed accordingly. Implementations may submit automatically generated security policies for review and approval before deploying.

FIG. 3 is a flowchart of example operations for analyzing a dataset of harvested browser data for a security perspective. The analysis varies depending upon the security products/services being used by the organization. Multiple security perspectives can map to one cybersecurity product/service. And a cybersecurity perspective can map to multiple products/services. For example, each of DLP and ZTNA security perspectives can map to firewall and CASB services. Analysis can be done with machine-learning models trained to identify usage patterns for different security perspectives. The example operations of FIG. 3 are with respect to one security perspective that informs security policy generations based on factors including usage patterns, distinction between personal and business usage, groups of users, and data movement. Factors for different security perspectives can vary.

At block 301, an analyzer identifies usage patterns based on browsing data and calculates usage statistics. An analyzer may apply heuristics-based rules to identify usage patterns, statistical analysis, and/or machine learning to determine frequency of access to web-based services/applications by different users of the organization. This can be based on header information in requests (e.g., URLs, domain names, network addresses) and/or information from application identifier analysis, often referred to as AppID. For instance, the analyzer can analyze the dataset to identify applications/services being accessed as secondary applications and services. For instance, a secondary application/service may enable execution of a script or rendering of an image or video.

The analyzer can identify which secondary applications/services are being used in the organization, access a cybersecurity threat intelligence source to determine whether any of the utilized secondary applications/services are high risk, and generate a security policy that allows for the secondary applications/services that are not high risk instead of a policy that blocks all of these and impedes productivity. As another example, the analyzer can determine from open tabs some content is often used and generate a policy to cache content from these sites to facilitate productivity.

At block 303, the analyzer differentiates between business use services and personal use services. An organization likely has a list of applications/services approved for the organization and a list of applications/services known as personal. Even with predefined lists of business and personal applications/services, users of an organization likely access an application/service not in a list. Thus, an analyzer will classify as personal or business some or all of the applications/services indicated in the harvested browser data. Classification can be done with a model that has been trained to classify based on header and body data of Hypertext Transfer Protocol (HTTP) messages. An analyzer can access another database or source that crawls the web and identifies domains as corresponding to business/productivity or personal use. An analyzer can also be programmed to access web pages that have information about unclassified applications/services, generate semantic embeddings from the web pages, and compare to semantic embeddings of permissible use cases for the organization.

At block 305, the analyzer identifies user cohorts corresponding to usage patterns. The analyzer analyzes the harvested browser data to determine user cohorts. For example, the analyzer can use a clustering algorithm to cluster users by user-related features in the harvested browser data, such as prefix of source addresses, geographic locations mapped to user identifiers, etc. The analyzer can also access a directory of the organization to ascertain user cohorts by departments or divisions of the organization or roles within the organization. This analysis can allow the analyzer to identify cohorts with different permission levels and/or job responsibilities that will influence security policies. For instance, the analyzer may identify a cohort of security researchers and determine the type of applications/services accessed by the security research cohort. A security policy can be generated that allows users in the security researcher cohort access to risky or malicious sites while blocking that access to others. As another example, the analyzer can identify a marketing cohort and generate a security policy that allows users of the marketing cohort to access the social media sites indicated in the browser harvested data as accessed by the marketing cohort while setting a security action for other users accessing social media sites.

At block 307, the analyzer determines access and movement of digital assets of the organization. The analyzer identifies cloud resources of the organization that are accessed, which includes downloading to endpoints and sharing. This information can information the generation of a security policy for controlling access and for adjusting configurations. For instance, a list of cloud resources that were downloaded or shared can be identified and compared against a class of resources that should be isolated. This can inform a policy that either blocks types of access or triggers a permission reconfiguration of the resource. In addition, the analyzer may determine a usage pattern that users are using a mixture of services/applications for filing storing and sharing including some that are non-enterprise grade. This usage pattern can be used to generate a security policy to block any non-enterprise grade file storing and/or sharing application/service.

At block 309, the analyzer calculates statistics for browser types, platforms, and access locations based on browser data. The analyzer identifies the various browser and platforms being used to access assets of the organization. The analyzer can then evaluate the identified browsers and platforms against approved browsers and platforms and generate security policies that prevent use of the prohibited browsers and/or platforms that are not supported or approved by the administrators of the organization. As an example, the information from the analysis may indicate that an unsupported browser or platform is popular among the users of the organization and lead the administrators to add the browser or platform to the approved and supported list. As another example, the analyzer can determine the use of unsigned browser extensions and, with the cohort analysis, determine that some users that use unsigned browser extensions are the security research cohort. Based on this information, a security policy can be generated that blocks use of unsigned browser extension by users not within the security research cohort.

The example operations are described with reference to a cybersecurity policy generator and analyzers for consistency with FIG. 1 and/or ease of understanding. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

### Variations

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general-purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine-readable medium(s) may be utilized. The machine-readable medium may be a machine-readable signal medium or a machine-readable storage medium. A machine-readable storage medium may be, for example but not limited to, a system, apparatus, or device, that employs one or a combination of electronic, magnetic, optical, electromagnetic, infrared, or semiconductor technology to store program code. More specific examples (a non-exhaustive list) of the machine-readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain or store a program for use by or in connection with an instruction execution system, apparatus, or device. A machine-readable storage medium is not a machine-readable signal medium.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

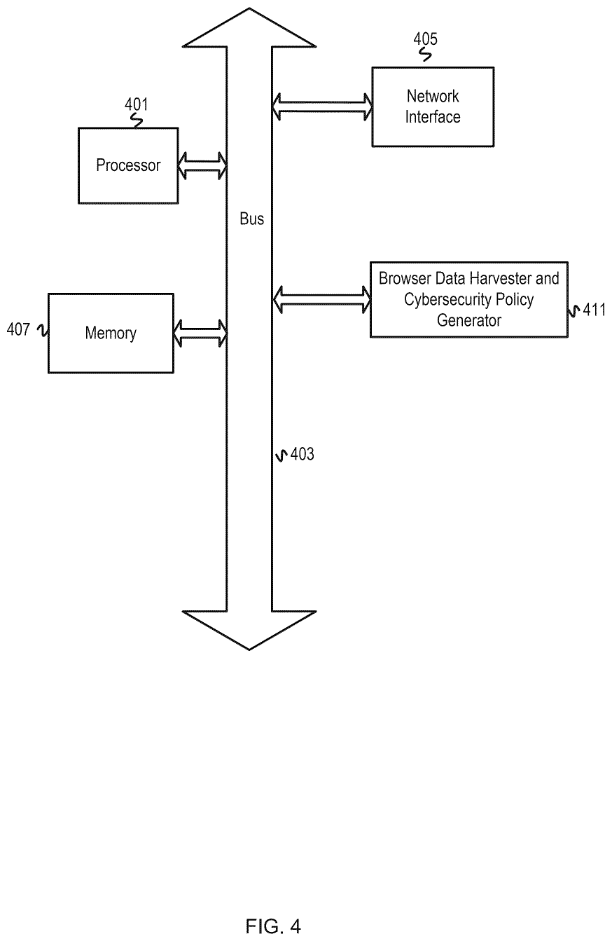

FIG. 4 depicts an example computer system with a browser data harvester and a cybersecurity policy generator. The computer system includes a processor 401 (possibly including multiple processors, multiple cores, multiple nodes, and/or implementing multi-threading, etc.). The computer system includes memory 407. The memory 407 may be system memory or any one or more of the above already described possible realizations of machine-readable media. The computer system also includes a bus 403 and a network interface 405. The system also includes a browser data harvester and a cybersecurity policy generator 411. The browser data harvester and a cybersecurity policy generator 411 leverages a browser extension to harvest browser data from across an organization by deploying instances of the browser extension to users who install the extension into one or more of their browsers. The deployed instances of the browser extension take snapshots of the browser data and communicate the snapshots of browser data to the browser data harvester and a cybersecurity policy generator Y11. The harvested data is aggregated into one or more datasets for analysis by the browser data harvester and a cybersecurity policy generator Y11 to determine usage patterns, browser/device profiles, and behaviors. The browser data harvester and a cybersecurity policy generator Y11 uses the analysis of the harvested data to intelligently construct security policies for the security products and/or services of an organization that are tailored to the behaviors of the individuals, groups, and organization to secure the organization while facilitating productivity. Any one of the previously described functionalities may be partially (or entirely) implemented in hardware and/or on the processor 401. For example, the functionality may be implemented with an application specific integrated circuit, in logic implemented in the processor 401, in a co-processor on a peripheral device or card, etc. Further, realizations may include fewer or additional components not illustrated in FIG. 4 (e.g., video cards, audio cards, additional network interfaces, peripheral devices, etc.). The processor 401 and the network interface 405 are coupled to the bus 403. Although illustrated as being coupled to the bus 403, the memory 407 may be coupled to the processor 401.

1. A method comprising:
deploying a browser extension across an organization;
each instance of the deployed browser extension obtaining browser data from a corresponding browser instance;
aggregating the obtained browser data into a first dataset;
for each of a plurality of security perspectives,
analyzing the first dataset to determine usage patterns corresponding to the security perspective;
generating a security policy based, at least in part, on the determined usage patterns; and
deploying the security policies to policy enforcement points of the organization.

2. The method of claim 1, wherein analyzing the first dataset to determine usage patterns corresponding to each security perspective comprises, for each security perspective determining, based on the first dataset, web-based services being accessed and usage statistics of each service.

3. The method of claim 2, wherein generating a security policy for at least a first of the security perspectives comprises generating a security policy that indicates as allowed those of the services determined as satisfying low risk criteria and accessed beyond a threshold amount based on the usage statistics.

4. The method of claim 3, wherein generating a security policy for the first security perspective also comprises generating the security policy with indication of a security action for those of the services determined as not satisfying the low risk criteria but not identified as malicious.

5. The method of claim 2, wherein analyzing the first dataset to determine usage patterns corresponding to each security perspective comprises identifying, based on the first dataset, a first subset of the services corresponding to personal use and a second subset of the services corresponding to business use.

6. The method of claim 5, wherein generating a security policy for each security perspective comprises generating, for at least a data leakage prevention (DLP) perspective, a security policy indicating a DLP related action when accessing those of the services corresponding to personal use.

7. The method of claim 1 further comprising identifying user cohorts, wherein analyzing the first dataset for each security perspective also comprises analyzing based on the identified user cohorts, wherein generating a security policy for each security perspective comprises indicating an allowed browser-related behavior by users of a first of the user cohorts and blocking the browser-related behavior by users of a second of the user cohorts.

8. The method of claim 7, wherein the browser-related behavior comprises one of accessing a first service and using an unsigned browser extension.

9. The method of claim 1 wherein analyzing the first dataset to determine usage patterns corresponding to each security perspective comprises:
analyzing browser profile data collected across the organization by the browser extension instances for security posture management, wherein the browser data at least includes the browser profile data and browsing data,
wherein generating the security policy for each security perspective comprises generating one or more security policies for security posture management.

10. The method of claim 9, wherein analyzing the browser profile data comprises determining browser types, platforms, and statistics of usage for the browser types and the platforms, wherein generating one or more second security policies for security posture management comprises generating at least one security posture management policy that indicates at least one of configuration requirements, device management registration requirements, one or more disallowed browser types, one or more disallowed platforms, and browser trust constraints.

11. The method of claim 1, wherein analyzing the first dataset to determine usage patterns corresponding to security perspectives comprises analyzing the first dataset to determine caching strategies for content, wherein generating the security policy comprises generating the security policy indicating the caching strategies.

12. A non-transitory, machine-readable medium having stored thereon program code comprising instructions to:
deploy a browser extension across an organization;
aggregate into a first dataset browser data obtained from each instance of the deployed browser extension;
for each of a plurality of security perspectives,
analyze the first dataset to determine usage patterns corresponding to the security perspective;
generate a security policy based, at least in part, on the determined usage patterns; and
deploy the security policies to policy enforcement points of the organization.

13. The non-transitory, machine-readable medium of claim 12, wherein the instructions to analyze the first dataset to determine usage patterns corresponding to each security perspective comprise at least one of:
instructions to determine for each security perspective, based on the first dataset, web-based services being accessed and usage statistics of each service; and
instructions to determine caching strategies for content based on the usage patterns, wherein the instructions to generate the security policy comprise instructions to generate the security policy with indication of the caching strategies.

14. The non-transitory, machine-readable medium of claim 13, wherein the instructions to generate a security policy for at least a first of the security perspectives comprise instructions to:
generate a security policy that indicates as allowed those of the services determined as satisfying low risk criteria and accessed beyond a threshold amount based on the usage statistics and indicates a security action for those of the services determined as not satisfying the low risk criteria but not identified as malicious.

15. The non-transitory, machine-readable medium of claim 13,
wherein the instructions to analyze the first dataset to determine usage patterns corresponding to each security perspective comprise instructions to identify, based on the first dataset, a first subset of the services corresponding to personal use and a second subset of the services corresponding to business use.
wherein the instructions to generate a security policy for each security perspective comprise instructions to generate, for at least a data leakage prevention (DLP) perspective, a security policy indicating a DLP related action when accessing those of the services corresponding to personal use.

16. The non-transitory, machine-readable medium of claim 12, wherein the program code further comprises instructions to identify user cohorts, wherein the instructions to analyze the first dataset for each security perspective also comprise instructions to analyze based on the identified user cohorts, wherein the instructions to generate a security policy for each security perspective comprise instructions to indicate an allowed browser-related behavior by users of a first of the user cohorts and blocking the browser-related behavior by users of a second of the user cohorts.

17. The non-transitory, machine-readable medium of claim 12 wherein the instructions to analyze the first dataset to determine usage patterns corresponding to each security perspective comprise instructions to:
analyze browser profile data collected across the organization by the browser extension instances for security posture management, wherein the instructions to analyze the browser profile data comprise instructions to determine browser types, platforms, and statistics of usage for the browser types and the platforms,
wherein the browser data at least includes the browser profile data and browsing data,
wherein the instructions to generate the security policy for each security perspective comprise instructions to generate one or more security policies for security posture management that indicates at least one of configuration requirements, device management registration requirements, one or more disallowed browser types, one or more disallowed platforms, and browser trust constraints, based at least partly on the analysis of the browser profile data.

18. An apparatus comprising:
a processor; and
a machine-readable medium having stored thereon instructions executable by the processor to cause the apparatus to,
deploy a browser extension across an organization;
aggregate into a first dataset browser data obtained from each instance of the deployed browser extension;
for each of a plurality of security perspectives,
analyze the first dataset to determine usage patterns corresponding to the security perspective;
generate a security policy based, at least in part, on the determined usage patterns; and
deploy the security policies to policy enforcement points of the organization.

19. The apparatus of claim 18, wherein the instructions to analyze the first dataset to determine usage patterns corresponding to each security perspective comprise at least one of:
instructions executable by the processor to cause the apparatus to determine for each security perspective, based on the first dataset, web-based services being accessed and usage statistics of each service; and
instructions executable by the processor to cause the apparatus to determine caching strategies for content based on the usage patterns, wherein the instructions to generate the security policy comprise instructions executable by the processor to cause the apparatus to generate the security policy with indication of the caching strategies.

20. The apparatus of claim 19, wherein the instructions to generate a security policy for at least a first of the security perspectives comprise instructions executable by the processor to cause the apparatus to:
generate a security policy that indicates as allowed those of the services determined as satisfying low risk criteria and accessed beyond a threshold amount based on the usage statistics and indicates a security action for those of the services determined as not satisfying the low risk criteria but not identified as malicious.

21. The apparatus of claim 19,
wherein the instructions to analyze the first dataset to determine usage patterns corresponding to each security perspective comprise instructions executable by the processor to cause the apparatus to identify, based on the first dataset, a first subset of the services corresponding to personal use and a second subset of the services corresponding to business use.
wherein the instructions to generate a security policy for each security perspective comprise instructions executable by the processor to cause the apparatus to generate, for at least a data leakage prevention (DLP) perspective, a security policy indicating a DLP related action when accessing those of the services corresponding to personal use.

22. The apparatus of claim 18, wherein the machine-readable medium has further stored thereon instructions executable by the processor to cause the apparatus to identify user cohorts, wherein the instructions to analyze the first dataset for each security perspective also comprise instructions executable by the processor to cause the apparatus to analyze based on the identified user cohorts, wherein the instructions to generate a security policy for each security perspective comprise instructions executable by the processor to cause the apparatus to indicate an allowed browser-related behavior by users of a first of the user cohorts and blocking the browser-related behavior by users of a second of the user cohorts.

23. The apparatus of claim 18 wherein the instructions to analyze the first dataset to determine usage patterns corresponding to each security perspective comprise instructions executable by the processor to cause the apparatus to:
analyze browser profile data collected across the organization by the browser extension instances for security posture management, wherein the instructions to analyze the browser profile data comprise instructions executable by the processor to cause the apparatus to determine browser types, platforms, and statistics of usage for the browser types and the platforms,
wherein the browser data at least includes the browser profile data and browsing data,
wherein the instructions to generate the security policy for each security perspective comprise instructions executable by the processor to cause the apparatus to generate one or more security policies for security posture management that indicates at least one of configuration requirements, device management registration requirements, one or more disallowed browser types, one or more disallowed platforms, and browser trust constraints, based at least partly on the analysis of the browser profile data.
